(19) United States
(12) Patent Application Publication
(10) Pub. No.: US 2008/0307057 A1
(43) Pub. Date: Dec. 11, 2008

(54) Method and system for providing a spam-free email environment

(76) Inventor: Gregory T. Prentiss, JR., Berlin, CT (US)

Correspondence Address: Thomas J. Monahan;Monahan & Costello, LLC, Attorneys at Law, 4154 Madison Avenue, Trumbull, CT, 06482, US

(21) Appl. No.: 11/810,793

(22) Filed: Jun. 7, 2007

(51) Int. Cl. G06F 15/16

(52) U.S. Cl. 709/206

(57) ABSTRACT

Spam-free electronic message system and method are described. A system and method for providing email or other electronic messages between users is described that comprises a centralized closed-loop communication network; a server(s) accessible through secured or encrypted connections for receiving and sending email between users; and a structured user protocol with an enforcement recourse process for users. The system provides a spam-free network system and method of operation.

### BACKGROUND OF THE INVENTION

1. Field of the Invention

The present invention relates to electronic mail (email) and messaging systems, and services. More specifically, the present invention comprises a method and system for email, in which users are able to combat and progressively eliminate spam or other unwanted messages.

2. Description of the Prior Art

By way of background, one of the contemporary challenges of electronic mail is the well established existence of global spam. It has been estimated that the cost of spam in terms of lost productivity reached $21.6 billion for the US alone in 2004 (2004 National Technology readiness survey, Feb. 3, 2005, prepared by Rockbridge Associates, Inc., Great Falls, Va.; sponsored by R. H. Smith School of Business, the University of Maryland, College Park, Md.). The occurrence of spam is increasing, NBC News reported that “spam is on the rise” and likely doubled in 2006 from 2005 because spammers continue to find more creative ways to get around spam filters (NBC Nightly News with Brian Williams, Jan. 22, 2007, reported by Rehema Ellis; Story: “It's not your imagination-spam is on the rise”). In addition to the nuisance and lost productivity from spam, it is also a vehicle or tool used to transmit computer viruses, and to perpetuate fraud and identity theft with “phishing” schemes. In a survey conducted by the Email Sender and Provider Coalition, it was clear that Email users want more control of inboxes (Reuters Limited, Mar. 27, 2007, reported by Rachelle Younglai; “Email users want more control of inboxes”).

A variety of methods have been developed in attempts aimed at preventing or reducing the amount of spam messages. Other terms for “spam” include unsolicited bulk email (“UBE”), unsolicited commercial email (“UCE”) and junk email. The spam problem has led to the development of anti-spam products such as spam filtering software, but it is clear that these products have had little long-term effect. Anti-spam software products typically rely on the filtering and scanning of messages for specific patterns, keywords, executable attachments, other known viruses and worms, while white list features are used to identify approved senders. However, none of these provide complete solutions to the spam problem for the following reasons: (i) spam filters don't really prevent spam or influence “spammers” to stop sending spam; (ii) spammers continue to find new ways to circumvent these spam filters (iii) spam filters aren't effective with forged email messages (iv) spam is distributed to various spam folders which still need to be inspected by the email user to check for legitimate email that gets caught by the filter; (v) the email user gets caught in an endless cycle of updating the spam-filtering software and definitions; (vi) the data drain on the internet continues, wasting valuable resources of capacity (i.e., it is reported that AOL blocks 80-85% of all email that crosses its wires; Reuters Ltd., Mar. 27, 2007, reported by Rachelle Younglai, “Email users want more control of inboxes”); and (vii) anti-spam products provide no effective remedy or recourse process to use against abusive users.

Beyond the limitations of spam filtering, the existing internet's email system lacks a method for providing centralized accountability of a user protocol, and a respective enforcement process for the purposes of mail exchange.

Given the foregoing, it will be appreciated that a new approach is required to overcome the aforementioned difficulties and deficiencies of the prior art in resolving the spam problem. The present invention is directed toward this goal.

Accordingly, it is an object of the present invention to provide a new and improved method to combat and progressively eliminate spam, or other unwanted email/messages in ultimately creating a spam-free message exchange environment.

Another object of the present invention is to provide a system wherein spam-free electronic messages may be transmitted.

Another object of the present invention is to provide a method and system of defined Mail Purpose Types, for use by senders to identify the intention of their messages, thereby providing recipients a more efficient method to immediately understand the email's intended purpose and manage said volume of email with greater ease.

Yet another object of the present invention is to provide a system that limits the number of recipients for any messages based on the sending user's history of behavior within the service, length of time they have been a user, level of contractual system service, or similar criteria.

These and other objects and advantages of the present invention and equivalents thereof, are achieved by the methods and systems of the present invention described herein and manifest in the appended claims.

### SUMMARY OF THE INVENTION

The present invention provides a method and system to combat spam and progressively eliminate it, or other unwanted email/messages, in ultimately creating a spam free message exchange environment, with a continual reconciliation process for senders and recipients (all users). This method and system can be identified by the acronym CapeMax™ (Centralized, Accountability, Protocol, Enforcement, Mail, “X” Exchange) and takes a new approach to the spam problem by starting with a centralized closed-loop communication network email system, via the structure of an extranet. Thereby providing a practical means of validating the integrity of any message for the purposes of holding abusive senders accountable; establishing a protocol of use as the standard to define abusive sending behavior and define the appropriate recourse process; and the closed-loop email system being necessary to enforce respective penalties/consequences.

The present invention describes a system for providing email or other electronic messages between users that comprises (i) centralized closed-loop communication network; (ii) a server(s) accessible through secured or encrypted connections for receiving and sending email between users; (iii) a structured user protocol having an enforcement recourse process for said users; and where the system, with an enforcement recourse process of a user protocol, provides users with a spam-free network system. The communication network of the invention may conveniently be selected from the group consisting of extranet, intranet, Wide Area Network (WAN), Virtual Private Network (VPN) and any combinations of these systems. A preferred embodiment of the communication network of the invention is an extranet.

In the system of the invention, the secured or encrypted connections are preferably selected from the group consisting of Secure Sockets Layer (SSL) and Transport Layer Security (TLS) or optionally tunneling.

The server(s) of the system of the invention may be accessible through a secured login. Also, the server(s) of the system (i) may be accessible by either wireless or wired connections (including personal digital assistants (PDA's), and (ii) may optionally provide email or other electronic data storage.

The enforcement recourse process of the system of the invention preferably provides penalties for users that are selected from the group consisting of: service cancellation, service limitation, probationary user status, financial payments, and any combinations of these or other penalties that may be included in the recourse process from time to time. Also, the enforcement recourse process may further provide a means for users to challenge any penalty or penalties of the enforcement recourse process.

The system of the invention preferably has at least one website, but may have a plurality of websites. The invention system may be accessible by users' computers through any internet connection, through any secured web browser or email software configured to access the system.

Preferably, the system of the invention has a user protocol that provides for mandatory classification of electronic messages by Mail Purpose Type. Mail Purpose Type classifications are preferably selected from the group consisting of person-to-person messages, official correspondence, group correspondence, business networks, news and information, and advertisements and promotions. It is understood that classifications may change from time to time by deletions of existing classifications, or alternatively by additions of new Mail Purpose Type classifications.

In addition, the system of the invention may optionally provide users with a means to select a purge timeframe for at least one of the different Mail Purpose Type classifications.

The enforcement recourse process of the user protocol of the system can in a preferred embodiment provide a means for identifying and remedying unwanted email and a means for identifying and remedying mistyped (“MT”) Mail Purpose Type email. The user protocol may optionally limit or otherwise restrict the number of recipients which can be addressed to any one email or other electronic message based upon a user's history of use, length of time they have been a user, or a user's selected type or level of service, or other criteria.

In addition to a spam-free network system, the present invention describes a method for delivering spam-free email or other electronic messages between users that comprises providing a system having (i) a centralized closed-loop communication network (ii) a server(s) accessible through secured or encrypted connections, and (iii) a structured user protocol having an enforcement recourse process; and receiving and sending email or other electronic messages between users within system. The method of the invention further includes selecting the communication network system from the group consisting of extranet, intranet, Wide Area Network (WAN), Virtual Private Network (VPN) and any combinations thereof. A preferred embodiment involves selecting an extranet system as the communication network.

The secured or encrypted connections of the method of the invention are conveniently selected from the group consisting of Secure Sockets Layer (SSL) and Transport layer Security (TLS) or optionally tunneling.

The process of the invention (i) can access server(s) with a secured login; (ii) can access said server(s) with wireless or wired connections (including personal digital assistants (PDA's); and (iii) can provide email or other electronic data storage to the system server(s). In addition, the method of the invention preferably provides an enforcement recourse process that has penalties for users that include, but are not limited to, service cancellation, service limitation, probationary user status, financial payments, and any combinations thereof. Penalties may be added or deleted from the enforcement recourse process of the user protocol from time to time. In one embodiment of the method of the invention, a means for users to challenge the penalties of the enforcement recourse process is provided.

The invention method provides in various embodiments (i) at least one website to the spam-free network system; (ii) includes accessing the system of the invention by users' computers through any internet connection, through any secured web browser or email software configured to access said system; (iii) includes classifying electronic messages according to the user protocol by Mail Purpose Type; (iv) includes selecting Mail Purpose Type from the group consisting of, but not limited to, person-to-person messages, official correspondence, group correspondence, business networks, news and information, and advertisements and promotions; (v) provides users with a means of selecting purge timeframes for at lest one of the Mail Purpose Types (vi) provides a structured user protocol having an enforcement recourse process with a means for identifying and remedying unwanted email or other electronic messages; (vii) provides a structured user protocol having an enforcement recourse process with a means for identifying and remedying mistyped (“MT”) Mail Purpose Type email; and (viii) provides optionally limiting or otherwise restricting the number of recipients which can be addressed to any one email or other electronic message based upon a user's history of use, length of time they have been a user, or a user's selected type or level of service.

For purposes of this invention, a centralized closed-loop communication network is any extranet, intranet, Wide Area Network (WAN), Virtual Private Network (VPN), or combinations thereof. Unless otherwise defined, all technical and scientific terms used herein have the same meaning as commonly understood by one of ordinary skill in the art to which this invention belongs. Although method and materials similar or equivalent to those descried herein can be used in the practice or testing of the present invention, preferred methods and materials are described below. All publications, patent applications and other references mentioned herein are incorporated by reference in their entirety. In the case of conflict, the present specification, including definitions, will control. In addition, the materials, methods and examples are illustrative only and not intended to be limiting.

Other features and advantages of the present invention will be apparent from the following detailed description, and from the claims.

### BRIEF DESCRIPTION OF THE DRAWINGS

FIG. 1 is a schematic diagram of an email system operating through the existing internet's open email system is (“Usual Method 1”).

FIG. 2 is a schematic drawing of a second prior art method for sending and receiving email (“Usual Method 2”).

FIG. 3 is an illustration of the existing internet email system.

FIG. 4 is a schematic drawing illustrating spam filtering problems with forged messages using the existing internet email system.

FIG. 5 is a schematic drawing illustrating spam filtering problems with legitimate email.

FIG. 6 is a schematic drawing illustrating a Spam Filter Insanity Cycle.

FIG. 7. is a schematic drawing illustrating the centralized closed-loop communication network system of the invention (CapeMax System).

FIG. 8 is a schematic drawing of a typical format of an electronic mail message.

FIG. 9 is a schematic drawing of a sample format of an electronic mail message of the centralized closed-loop electronic mail system of the invention.

FIG. 10 is a schematic drawing of a sample format of an electronic mail message of an extranet electronic mail preferred embodiment system of the invention including sample electronic Mail Purpose Type identification.

FIG. 11 is a schematic drawing of a recourse process for users of the extranet electronic mail system of the invention.

FIG. 12 is a schematic drawing of the CM1 recourse process of FIG. 11 for Unwanted Email, leading to the sub-processes for unwanted email or UW processes.

FIG. 13 is a schematic drawing of the CM2 recourse process of FIG. 11 for Mail Purpose Type challenges, leading to the sub-processes for mistyped mail or MT Processes.

FIG. 14 is a schematic drawing of the Level 1 UW recourse process of FIG. 12.

FIG. 15 is a schematic drawing of the Level 2 UW recourse process of FIG. 12.

FIG. 16 is a schematic drawing of the Level 1 MT recourse process of FIG. 13.

FIG. 17 is a schematic drawing of the Level 2 MT recourse process of FIG. 13.

### DETAILED DESCRIPTION OF THE INVENTION

The present invention provides a method and electronic mail system for removing electronic mail (email) spam messages. The term “spam” is also known as unsolicited bulk electronic mail (“UBE”) and unsolicited commercial electronic mail (“UCE”). The invention provides a structured user protocol and recourse process for parties receiving email to address any unwanted email. In the present invention there is provided an extranet or closed-loop network where there are escalating risks and consequences for sending parties that influence sender's behavior and thereby discourage, manage, limit, reduce or eliminate spam.

In the present invention, the limitations inherent in earlier attempts to filter spam by screening the contents of email messages for key words, phrases and other patterns that presumptively indicate the presence of spam in an email are resolved. In such filtering systems, some legitimate mail may be wrongly identified as spam and some spam may be characterized as legitimate email. With filtering systems, the spammers and the spam filter designers get involved in a continuing cycle of countering each other's techniques. Also, filtering technologies rely on technical objective definitions of spam, whereas in reality the definition and interpretation of spam is better defined by the parties that receive and send email. There is a subjective element of spam in that one party's spam may be another party's legitimate email. In view of the fact that there are no effective consequences for the senders of spam, it is unlikely that spam filters will either resolve the overall spam problem or mitigate the waste in the internet's data delivery exchange capacity that is consumed by the sending of spam.

The present invention provides a system and method for email that may conveniently be identified by the acronym CapeMax (Centralized, Accountability, Protocol, Enforcement, Mail, “X” Exchange). CapeMax provides a method for reducing and/or eliminating the total volume of nuisance electronic mail (Spam) that comprises an effective enforcement recourse process for email recipients and a systematic protocol for organizing messages based on their intended purpose, or Mail Purpose Type. More particularly, the present invention provides an internet mail system, operating through a secured web browser (i.e., an extranet system), that places the responsibility of mandatory Mail Purpose Type designation of email messages on the sending party, while simultaneously providing the email recipient party with an enforcement recourse process for improperly classified messages, mistyped (MT).

In a preferred embodiment, the enforcement recourse process available to the recipient party that receives either an improperly classified electronic message(s) or an unwanted message(s) involves the imposition of a penalty. Also, the present invention provides a schedule limiting the number of email recipients that any one message can be addressed to based on the length of time they have been using the service/system and/or a service level to address the relative risk potential of possible abuse. A principal objective of the present invention is to provide a system and method that promotes the efficient exchange of email by creating a systematically and financially impractical environment for the operation of “spammers” and other undesired email senders.

There are three important components of the present invention that provide an essentially spam-free system: (1) a centralized closed-loop communication network for email (2) a server(s) accessible through secured or encrypted connections for receiving and sending email between users (3) a structured user protocol having an enforcement recourse process for email recipients to hold system abusers accountable; and wherein said system provides a spam free network system. The system of the invention provides an extranet as the preferred embodiment, accessible only by registered users through a secure web browser login from the internet (i.e., a registered user goes to a login website and logs in with a user name and password). The present system provides a centralized closed-loop communication network for an email system and service in the form of web-based application products, wherein all email data storage and exchange is confined to known databases and servers connected through the security of the extranet or other secure internet exchange. Also, the present invention provides a specific user protocol (i.e., the CapeMax User Protocol) which also establishes limits of recipient distribution by sending parties (i.e., the number of possible recipients of any one message is limited according to a schedule of limits of which are defined by the user protocol terms based on length of time a user has been registered or other criteria. The system of the present invention has requirements for sending parties to properly identify all messages by System Defined “Mail Purpose Types”.

The System Defined “Mail Purpose Types” of the invention allow messages to be sorted and placed in different sub-inboxes, according to Mail Purpose Types, upon receipt by the designated recipient(s). Upon receipt of an email message, the receiving party may choose to challenge the Mail Purpose Type which the sending party assigned if the message was not typed properly (i.e., consistent with the current “user protocol”) and may issue a complaint to the hosting service party. Such a complaint will be logged by the hosting service party which will notify the sender of the alleged violation and place the sender's account on an “aware status”. If a second complaint is made by the same recipient about the same sender within a defined period prescribed by the current “user protocol”, a tier one (1) fine or penalty may be charged to the violating sender. A portion of the collected fines may be paid to the violated recipient(s). If the cycle of violation between a sender and recipient(s) is repeated, the fines may escalate to higher tiers based on the current “user protocol”, or depending on the judgment of the hosting service party's administrator, the sender's account may be closed, placed on probationary statues, or placed in inactive status for a period also based on the current “user protocol”, and/or until a satisfactory resolution is reached.

For messages that are typed properly upon receipt, but which are not wanted to be continued by the receiving party, the receiving party may choose to issue a “do not send mail request” (DNSMR) to the sending party, which request will also be logged with the hosting service party. Thereafter, the sending party has a short period to respond, to update their records, and to send an acknowledgment message to the hosting party that will be matched with the original request and appropriately logged. The period to respond is based upon the current “user protocol”. In the event the original sending party does not provide and acknowledgement to the hosting service parting within the required time period, the original sending party's account will be placed on a “probationary user status” depending on the judgment of the hosting service party's administration. Thereafter, if the original recipient receives another message from the same sender, the recipient may issue a complaint to the sender referencing the original “do not send mail request”, which will be matched and logged by the hosting service party. An investigation will then be performed by the hosting service party. If both the original “do not send mail request” and the complaint are valid based on the current “user protocol”, a tier one (1) fine will be charged to the violating party and a portion of the collected fines may be paid to the violated recipient(s). If the cycle of violation between a sender and recipient(s) repeats, the fines may escalate to higher tiers based on the current “user protocol”, or depending on the judgment of the hosting party's investigator/administrator, the sender's account may be closed, placed on probationary user status, or placed in an inactive status for a period based on the current “user protocol”, and/or until a satisfactory resolution is reached.

One of the key problems with spam filtering is that it relies on some technical definitions of spam. Whereas in reality the definition and interpretation of spam is better defined by the parties that receive and send email. There is a subjective element of spam in that one party's spam may be another party's legitimate email. The nature of spam is that it is very subjective. Spam filtering relies on some technical definitions of spam. Whereas in reality the definition and interpretation of spam is better determined by the parties sending and receiving email. The complete solution to addressing the spam problem lies within some process of continual reconciliation between senders and recipients.

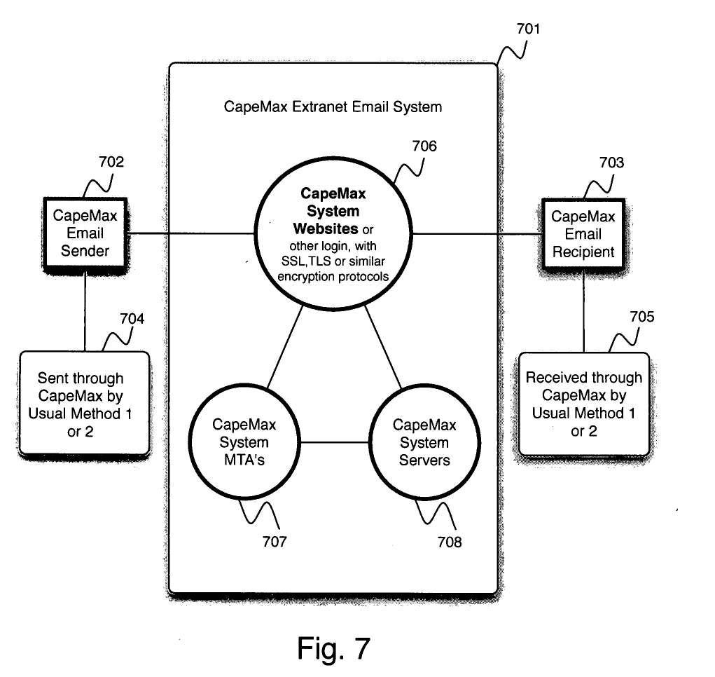

The present invention provides a method and system to combat spam and progressively eliminate it, or other unwanted email/messages, in ultimately creating a spam free message exchange environment, with a continual reconciliation process for senders and recipients. As illustrated in FIG. 7, this method and system can be identified by the acronym CapeMax (Centralized, Accountability, Protocol, Enforcement, Mail, “X” Exchange). CapeMax provides a centralized closed-loop communication network for email, via the structure of an extranet, which is established over the internet with Secure Sockets Layer, Transport Layer Security, or similar encryption protocols. The CapeMax system provides a practical means of validating the integrity of any message for the purposes of holding abusive senders accountable; establishing a user protocol as the standard to define abusive sending behavior and defines the appropriate enforcement recourse process; and the closed loop email system being necessary to enforce respective penalties/consequences. The present invention overcomes the limitations inherent in earlier attempts to filter spam by screening the contents of email messages for key words, phrases and other patterns that presumptively indicate the presence of spam in an email message. CapeMax provides a structured user protocol and enforcement recourse process for parties receiving email to address any unwanted email. In the present invention there is provided an extranet or closed-loop network where there are escalating risks and consequences for sending parties that influence sender's behavior and thereby discourage, manage, limit, reduce or eliminate spam.

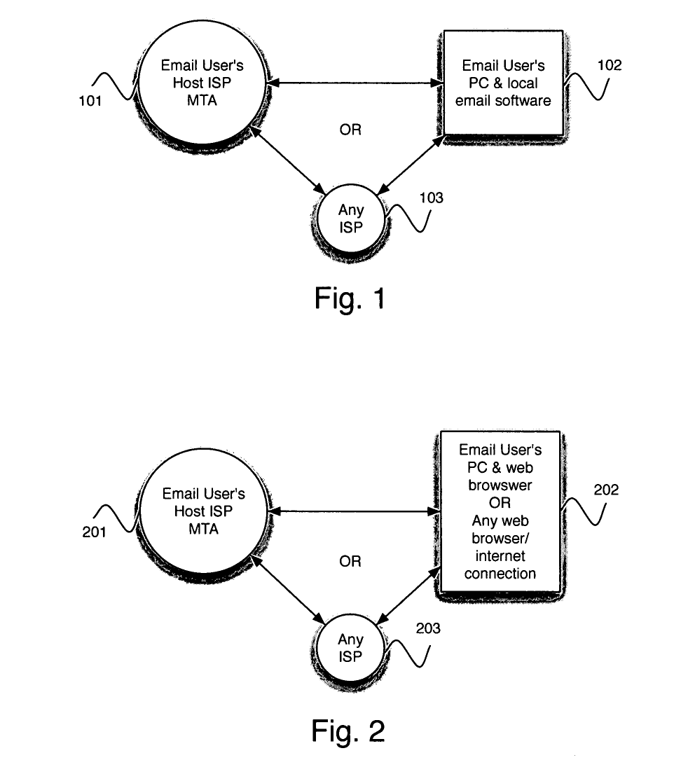

Through the existing internet's open email system, there are basically two prior art usual methods of sending and receiving email that are illustrated in FIGS. 1 and 2. Referring initially to FIG. 1, a schematic diagram of an email system operating through the existing internet's open email system is shown (“Usual Method 1”). In Usual Method 1 the email user downloads and/or uploads email messages through an email software program, which is installed on their personal, family or assigned computer 102. Two common email programs that do this are Outlook and Eudora. To download or upload email, the email user connects to the Internet through their host internet service provider (Host ISP) and its mail transfer agent (MTA) 101 or through any internet service provider (Any ISP) 103, such as when the email user may be traveling (e.g. hotels, airports) or other public/private internet access systems, which then connect to the email user's Host ISP 101. After which, said email software can be used to exchange email.

Referring now to FIG. 2, illustrated is a second prior art method for sending and receiving email (“Usual Method 2”). In Usual Method 2 the email user accesses their email account(s) through a website. Basically they are using a web browsing software program (e.g. Firefox, Safari, or Internet Explorer) instead of a specific email software program. This may be done from their personal, family or assigned computer; or from a shared or public computer (e.g. Library, Internet Café) 202. They use the web browsing program to connect to the internet through either their Host ISP 201 or any ISP 203, in the same manner as done for regular web browsing. Then the email user can go to their email service's website, login and exchange mail through the website.

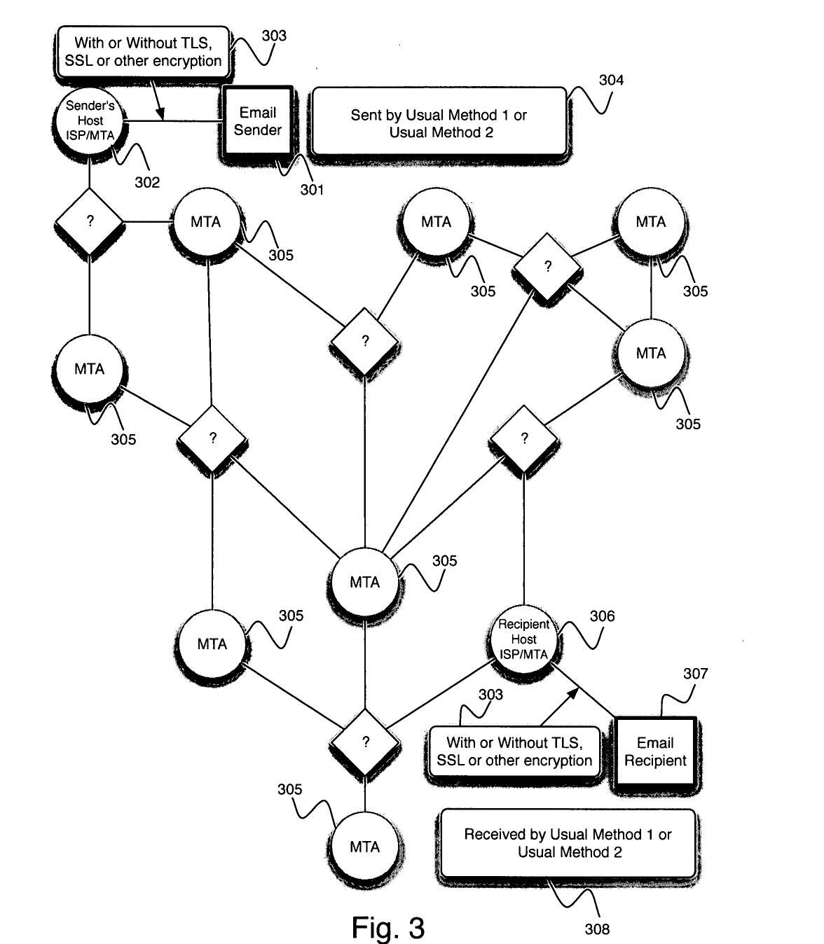

Referring now to FIG. 3, illustrated is the existing internet email system. By nature of its structure, the Internet's existing email system doesn't lend itself to the level of security necessary to effectively combat spam. FIG. 3 demonstrates this deficiency. In this figure, the Email Sender 301 can connect to their Host Internet Service Provider (ISP) 302, with or without Transport Layer Security (TLS), Secure Sockets Layer (SSL) 303 or other encryption and send a message, by Usual Method 1 or 2 304. The Host ISP and it's Mail Transfer Agent (MTA) 302 transfer the message through any number of MTA's 305 around the globe until it reaches the email Recipient 307 by Usual Method 1 or Usual Method 2 308 via Recipient's Host ISP & MTA 306. While this exchange between MTA's 305 is rather efficient, it is also one of the weaknesses of the existing Internet's email system and a key obstacle to effectively address the problem of Spam; for this structure is not sufficient to validate the message integrity with any reasonable certainty, in order to hold any abusive senders accountable.

Referring now to FIG. 4, illustrated are spam filtering problems with forged messages using the existing internet email system 401. Email forgery is a tactic used by spammers to circumvent spam filters. Once these types messages are received they are generally recognized as spam, unless they are “phishing” messages; “phishers” use email forgery in attempts to appear as legitimate institutions and trick recipients into revealing sensitive personal information to perpetrate identity theft, credit card fraud or other fraudulent activities. One of the fundamental problems with much of spam filtering is that it is not very effective with identifying such forged messages. FIG. 4 demonstrates this ineffectiveness. Party B 403 has spam filtering from its Host ISP 405 and/or locally on their PC. Party B 403 regularly expects to receive email from Party A 402. Therefore, filtering is setup to allow email from Party A 402. The email software accepts email # 1, as Party A 402 is an approved sender. However, it also accepts email # 2 from Party C 404 because it appears to be from Party A 402. Within the existing email system 401, shown is Party A's Host ISP 406 and Party C's Host ISP 407.

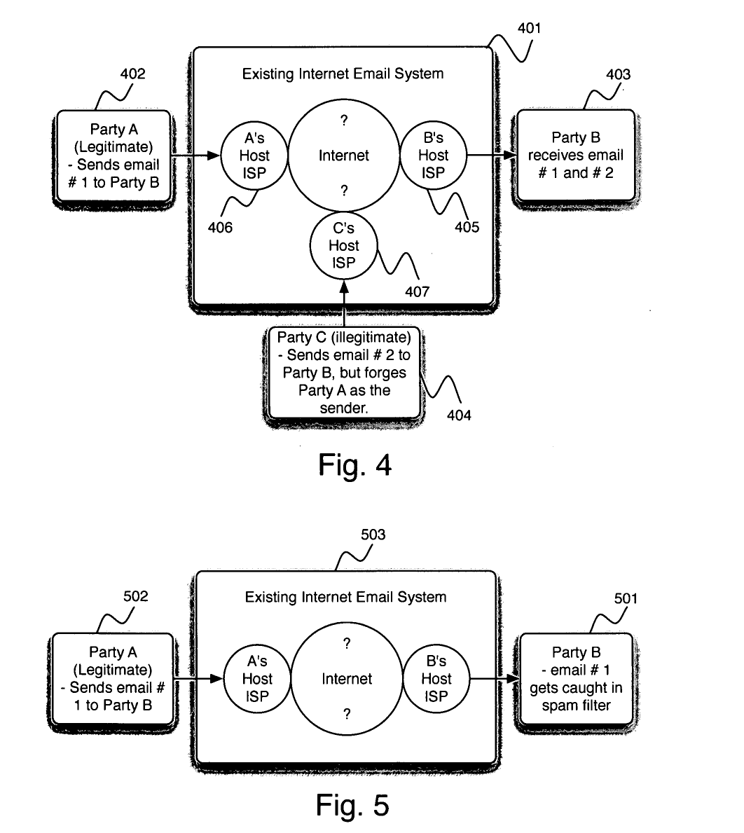

Referring now to FIG. 5, spam filtering problems with legitimate email are illustrated. Spam filters often catch legitimate email, classifying it as spam. FIG. 5 demonstrates this problem. Party B 501 has spam filtering from its Host ISP and/or locally on their PC. Party B occasionally receives email through the existing internet email system 503 from Party A 502, but something has changed since the last email exchange and email # 1 gets caught in the spam filter. Some of the possible causes are: (i) spam filtering software may have been updated and changed settings; (ii) Party A's 502 email # 1 may be somehow different than previous messages; or (iii) Party A's 502 email # 1 may contain key words, phrases or other content that the spam filter associates with spam. The result is that user's of spam filtering software still must sift through volumes of spam catch folders regularly, or risk the loss of potential important messages.

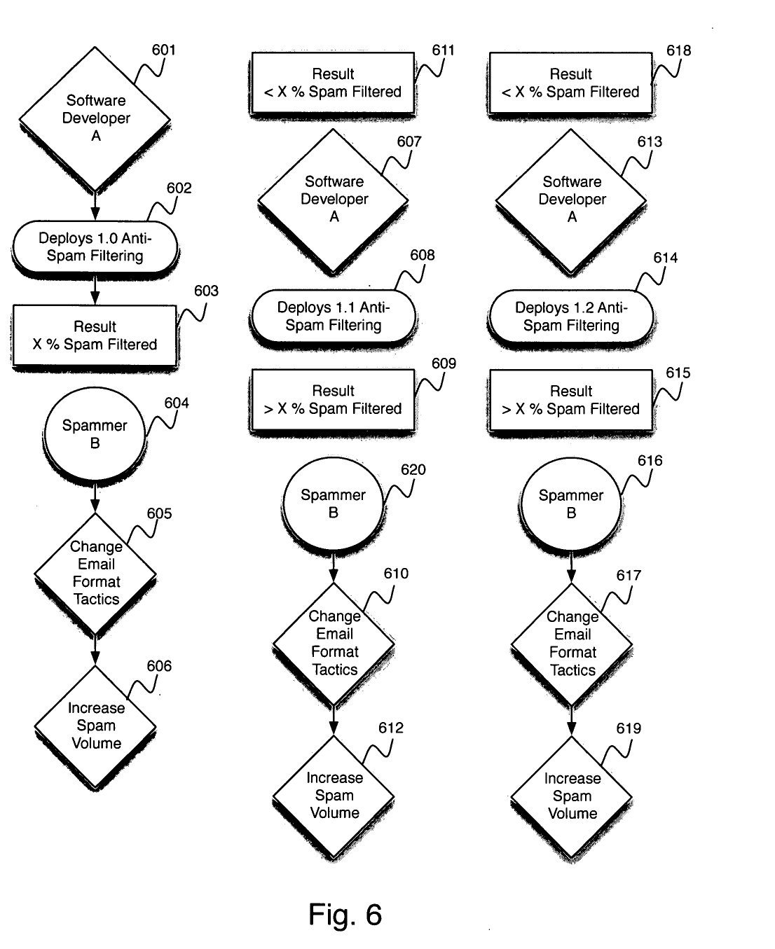

Referring now to FIG. 6, illustrated is a Spam Filter Insanity Cycle. An additional problem with spam filtering is the continual need to update the spam filter definitions. FIG. 6 demonstrates an example of this cycle. Software developer (A) 601 deploys Version 1.0 Anti-Spam Filtering 602, which results in X % spam filtered 603. In response, Spammer (B) 604 changes format of email 605 to circumvent spam filter, which increases volume of spam received 606, results in <X % spam filtered 611, and an increasing aggregate volume of recipient responses. Then Software developer (A) 607 updates & deploys Version 1.1 Anti-Spam Filtering 608, which results in >X % spam filtered 609. Responding once again, Spammer (B) 620 changes format of email 610 again to circumvent the updated spam filter and makes spam look more like non-spam, which results in <X % spam filtered 618; and increases volume of spam received 612 further, increasing aggregate volume of recipient responses. Software developer (A) 613 updates again & deploys Version 1.2 Anti-Spam Filtering 614, which results in >X % spam filtered 615. In response, Spammer (B) 616 changes format of email 617 again to circumvent updated spam filter and makes spam look more like non-spam <X % spam filtered 618; and increases volume of spam received 619 further, increasing aggregate volume of recipient responses. As spam and non-spam are more difficult to distinguish between one another, some legitimate and vital email gets caught. The cycle continues, email recipients remain frustrated because the spam problem is never resolved, spam does not abate, users still have to sift through folders of spam to find their legitimate email mis-filtered, and still have to update or buy new filtering software anyway.

Referring now to FIG. 7, illustrated is the system and method of the invention identified by the acronym Cape Max (Centralized, Accountability, Protocol, Enforcement, Mail, “X” Exchange). In this figure, a structure that provides part of the means for “Centralized Accountability” is established in the form of an extranet Email System 701. Contained within this extranet is an email system, accessible by an Email Sender 702 and Email Recipient 703 that is either sent through “Usual Method 1 or 2” 704 or received through “Usual Method 1 or 2” 705. The CapeMax Extranet Email System 701 has basic functionality similar to existing internet email systems with the additional functionalities and capabilities as described herein. The CapeMax Extranet Email system has System Websites 706 with Secure Sockets Layer (“SSL”) or Transport Layer Security (“TLS”), System Mail Transfer Agents 707 and System Servers 708.

One or more System Websites 706, or other login interfaces, along with System Servers 708 and Mail Transfer Agents 707 create this closed-loop email system, which is scalable to any size necessary. For purposes of this invention the term “closed” means that this email system does not exchange email with the Existing Internet Email System. This closing off accomplishes two key objectives. It eliminates the entrenched spammer dominated email environment and also creates an email system, which can be configured for this invention, its mail format, system and process capabilities.

Within the CapeMax system, email traceability is practical to validate, with reasonable certainty the origination and integrity of any message. This is an essential element for Centralized Accountability, and something that is lacking in the Existing Internet Email System (c.f., FIGS. 1-3).

In FIG. 7, a CapeMax member 702 logs into a secure CapeMax system 706, utilizing Secure Sockets Layer, Transport Layer Security or similar encryption protocols. This member is then able to send messages by Usual Method 1 or 2, and a receiving CapeMax member 703 logs in the same secure manner.

With “Centralized Accountability” established, a “User Protocol” is set forth whereas all users of the system of the invention (i.e., the CapeMax Extranet Email System 701) must agree to comply with a defined “User Protocol”. This procedure is similar to terms and conditions that must be agreed to when anyone installs a new piece of software on their computer. The CapeMax system 701 is privately managed, yet open to all that agree and maintain compliance with this “User Protocol” including changes that may occur from time to time. The “User Protocol” place responsibility on sending parties to be respectful of the recipients' time and resources. In order to go beyond just the spirit of “respectful”, the “User Protocol” establishes System Defined “Mail Purpose Types”, for nearly all email messages can be categorized into a small number of purposes common to nearly everyone. It is the responsibility of sending parties to assign the best fitting “Mail Purpose Type”.

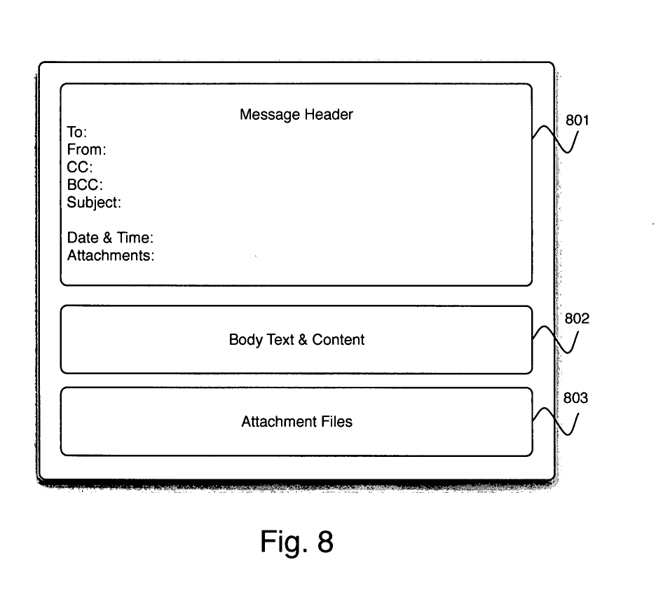

Referring now to FIG. 8, illustrated is the general format of present email messages. Email messages generally comprise a message header 801, a body text & content 802, and optionally attachment files 803.

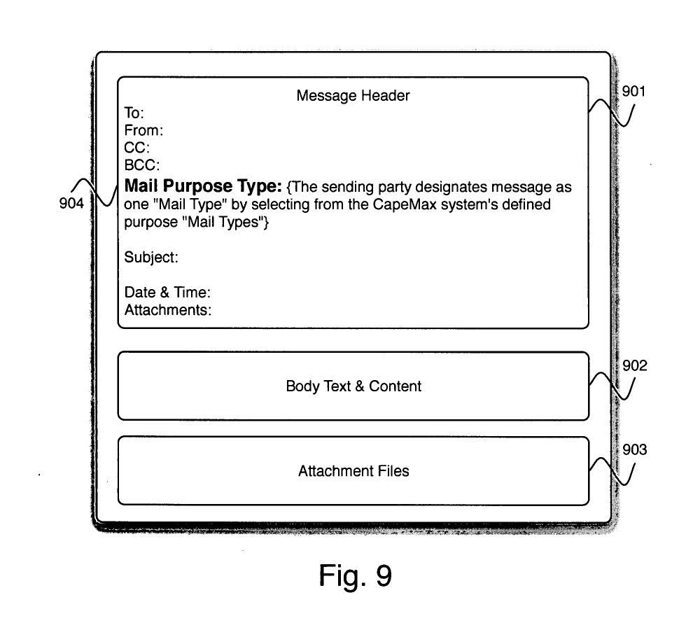

Referring now to FIGS. 9 & 10, illustrated is a typical format of an email message of the invention (CapeMax message). Referring now to FIG. 9, as with present email messages, CapeMax messages also generally comprise a Message Header 901, a Body Text & Content 902, and optionally Attachment Files 903. Although, a new message header field for “Mail Purpose Type” 904 is introduced into the Message Header 901 of the system of the invention, nearly all email messages can be classified into a small number of purposes common to most Email users. This new field of Mail Purpose Type 904 will be required for use by senders to identify the purpose of the message, according to a schedule of System Defined “Mail Purpose Types”.

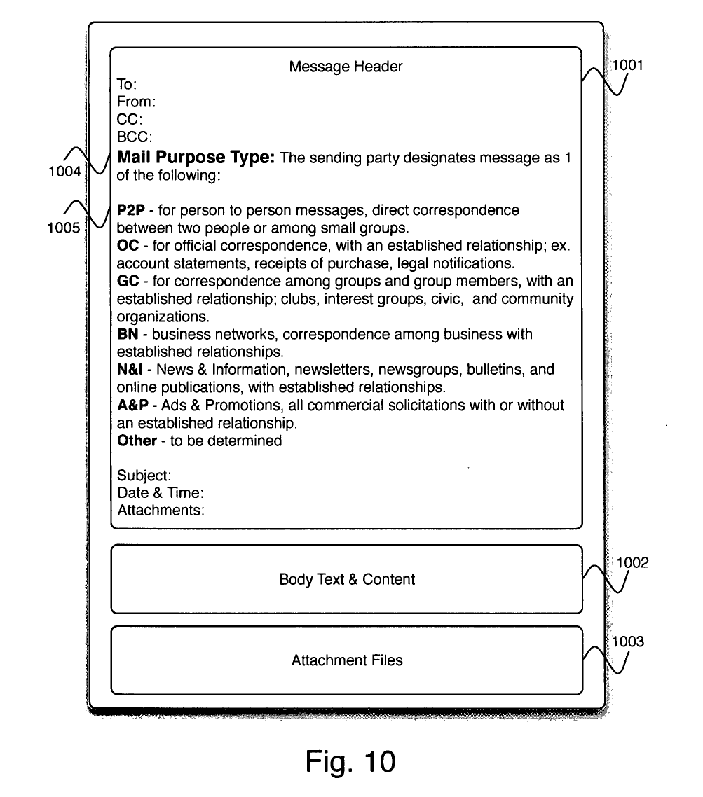

Referring now to FIG. 10, illustrated is a typical format of an email message of the invention (CapeMax message) with sample Mail Purpose Types. The message header 1001 comprises message header field for Mail Purpose Type 1004 having a list of several representative mail types 1005, a Body Text & Content 1002, and optionally Attachment Files 1003. It is the responsibility of sending parties to identify all email with the best fitting Mail Purpose Type 1004.

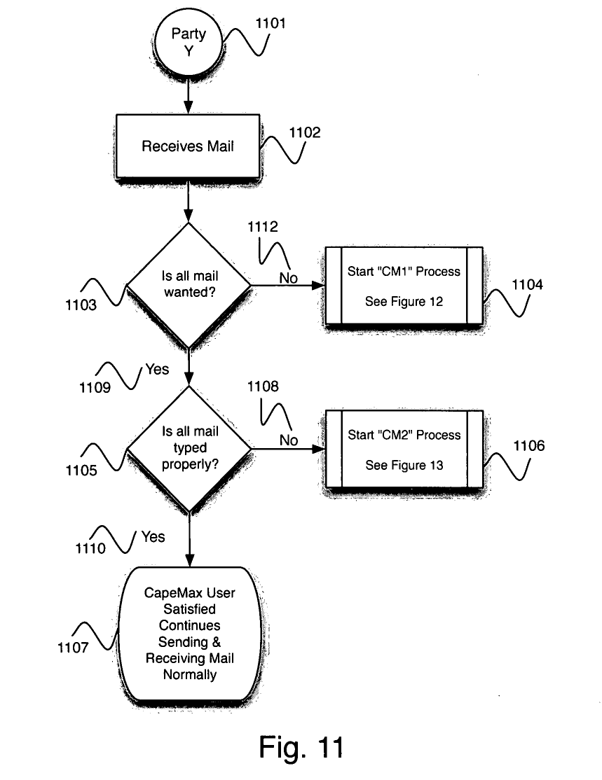

Referring now to FIG. 11, illustrated is a user recourse process of the invention (CapeMax). This recourse process applies the rules or terms of the “User Protocol” in order to provide “Enforcement” and removal of spam Email. The User Enforcement Recourse Process of the invention provides “Centralized” “Accountability” of “Protocol” and “Enforcement” in a “Mail” e“X”change system.

One of main purposes of the “User Protocol” is that it places responsibility on sending parties to be respectful of the recipients' time and resources. It requires sending parties to respond to recipient requests to cease sending more email/messages. In addition, it requires sending parties to honestly and properly identify the intended purpose of their email/message with the appropriate “Mail Purpose Type”. While this “User Protocol” may be broader in scope, there are two primary issues that CapeMax users will effectively be able to address with the Enforcement Recourse Process of FIG. 11, firstly that of unwanted mail (UW), and secondly that of Email that is mistyped (MT) according to the established “User Protocol” and respective Mail Purpose Type criteria.

FIG. 11 shows Party Y 1101, who upon receiving mail 1102, is able to query whether Email is wanted 1103. If there is unwanted mail (UW), Party Y 1101 may proceed with “CM1” Process. If Email receipt is wanted, Yes 1109, Party Y 1101 is able to query whether a given Email message is typed properly 1105 (i.e., determine whether there are or any Mail Purpose Type or mistyped (MT) email problems). If there are mistype (MT) problems (No 1108), Party Y 1108 may proceed with the “CM2” process 1106. If the Email message is typed properly (Yes 1110), then Party Y 1101 continues sending and receiving mail normally 1107.

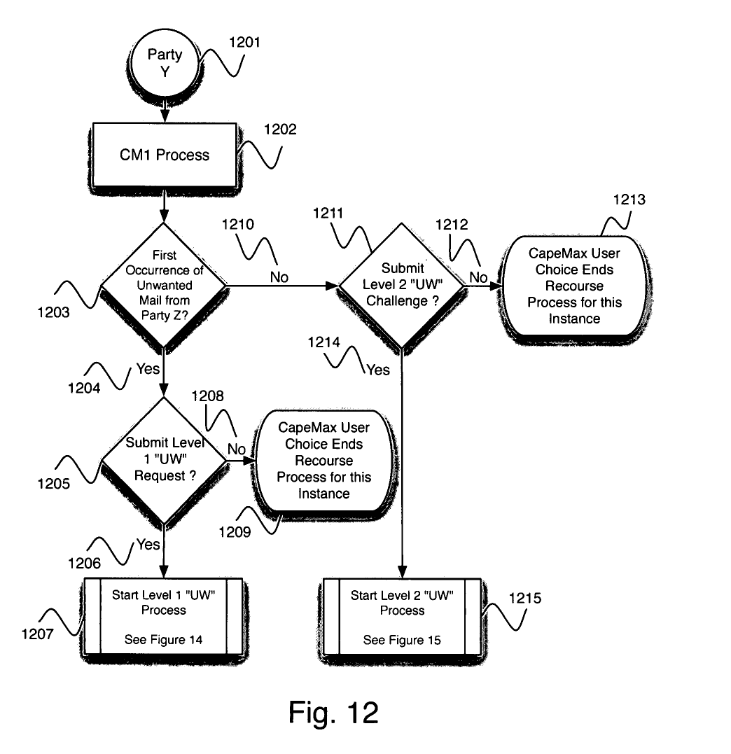

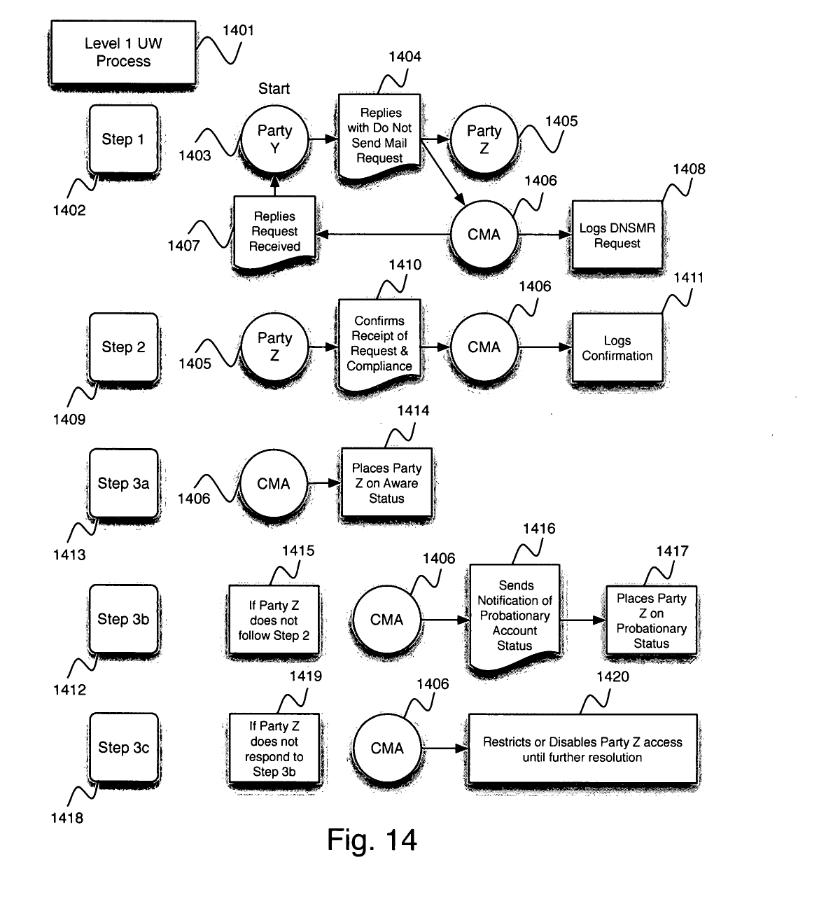

Referring now to FIG. 12, illustrated is a continuation/sub-process of the User Enforcement Recourse Process for unwanted Email (UW) identified in FIG. 11 as CM1 1104. This sub-process activates when a system user, party Y 1201 has indicated that they have received some unwanted mail (email/messages) and enters the CM1 Process 1202. Party Y 1201 queries whether or not the UW is a first occurrence of UW from Party Z 1203. Depending on whether this is the first occurrence or beyond a first occurrence determines the next course of action for the process. If it is a first occurrence (Yes 1204) of unwanted mail from this sender, Party Z (or senders with the same/similar message), and the user wants to submit a request to stop subsequent mailings, then the Party Y 1201 may Submit a Level 1 “UW” Request 1205 and elect (“Yes” 1206) to start a Level 1 “UW” Process 1207. The Level 1 UW Process 1207 is illustrated in further detail in FIG. 14. If the user, Party Y 1201, does not elect (No 1208) to submit a Level 1 UW Request 1205, then this election Ends the Enforcement Recourse Process for this instance 1209.

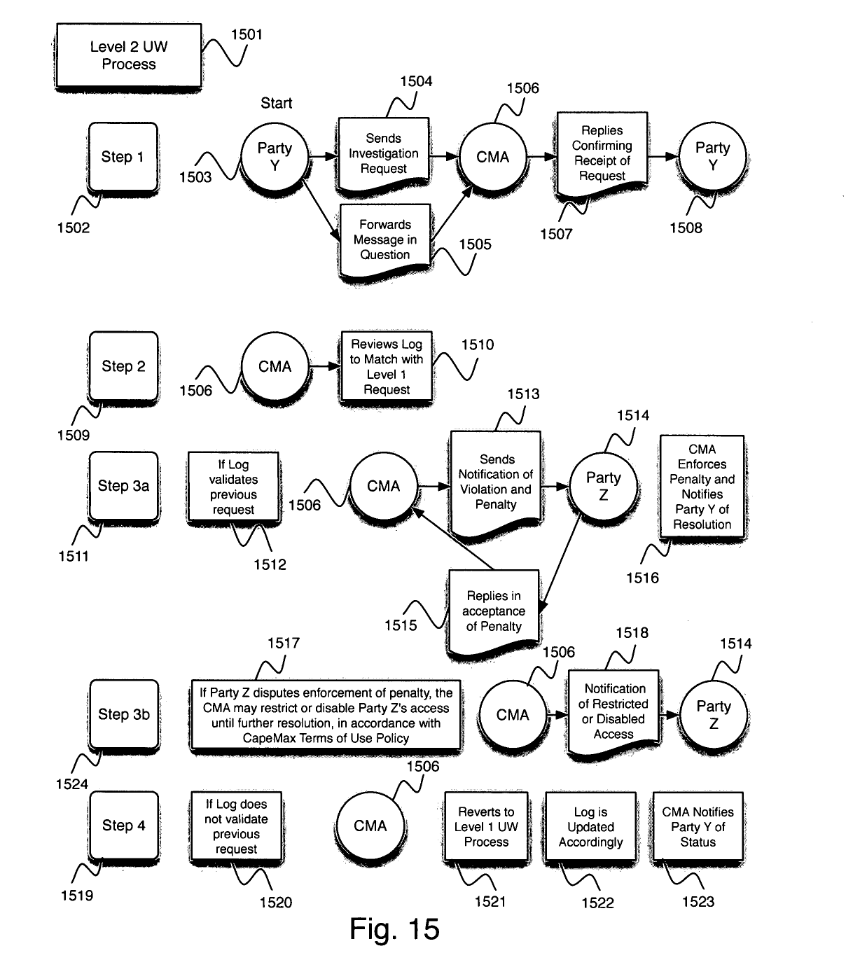

If it is beyond a first occurrence (No 1210) of unwanted mail from this Party Z sender (or senders with the same/similar message), then the user (Party Y 1201) decides whether of not to Submit a Level 2 UW Challenge 1211. If the user does not want (“No” 1212) to Submit a Level 2 UW Challenge 1211, then this election Ends the Enforcement Recourse Process for this Instance 1213. Alternatively, if the user (Party Y 1201) elects (“Yes” 1214) to submit a challenge (Submit Level 2 UW Challenge 1211 to investigate the non-response to prior request(s) to stop subsequent mailings, then the process moves to a Level 2 UW Process 1215. The Level 2 UM Process is illustrated in further detail in FIG. 15.

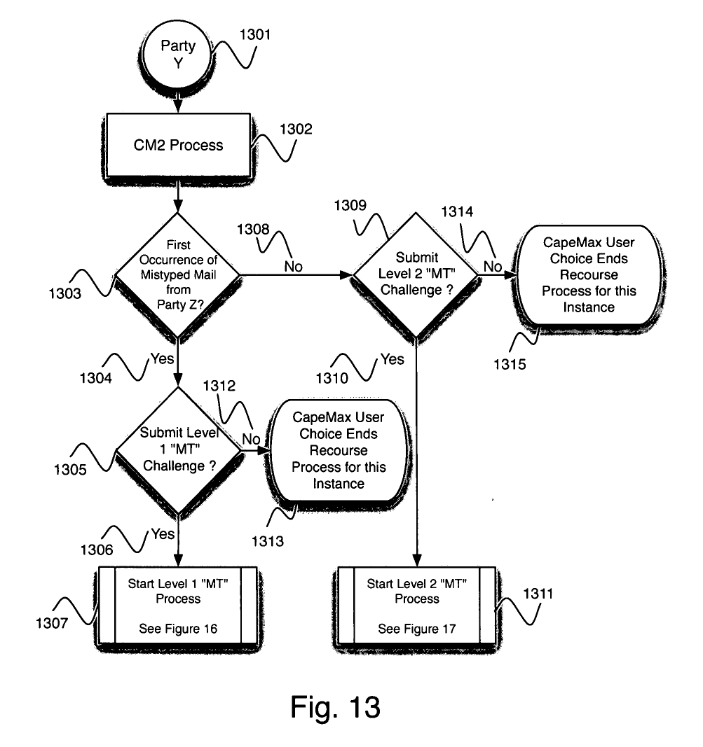

Referring now to FIG. 13, illustrated is the CM2 Process 1302. The CM2 Process 1302 is a further illustration of the Cape Max User Enforcement Recourse Process CM2 1106 of FIG. 11 for questions of Mail Purpose Type and MT Challenges. This process/sub-process activates when a system user (Party Y 1301) has indicated that they have received some mail (email/messages) that is wanted but has been improperly identified by its “Mail Purpose Type” (“No” 1108 in FIG. 11). Party Y 1301 is queried whether or not this is the First Occurrence of Mistyped Mail from Party Z 1303. Depending on whether this is the first occurrence or beyond a first occurrence determines the next course of action for the process.

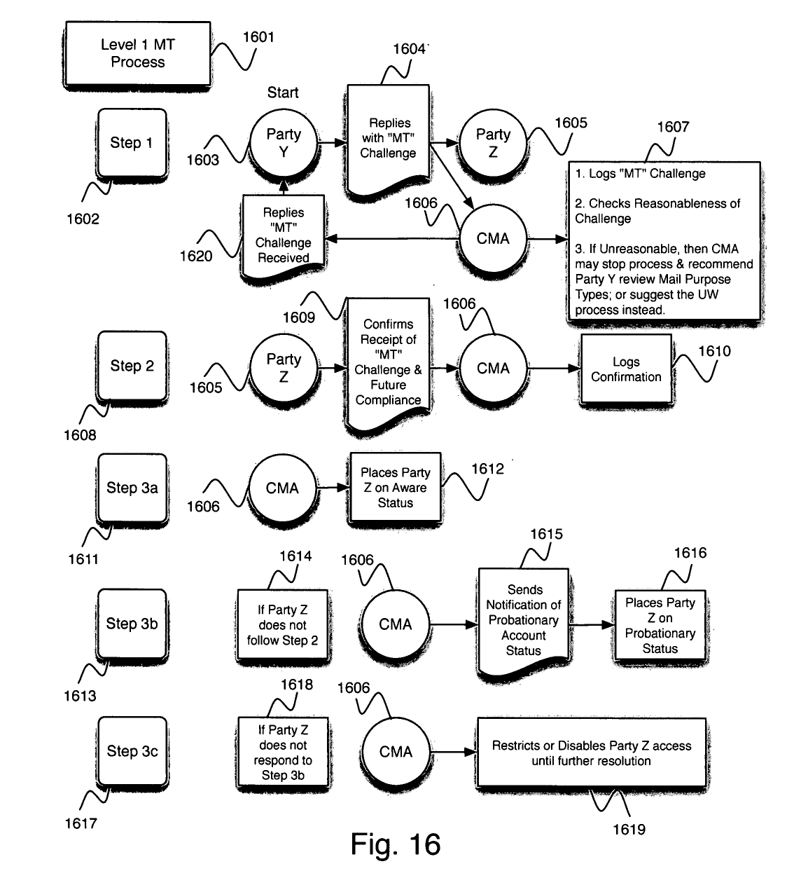

If this is a first occurrence (“Yes” 1304) of Mistyped Mail from this sender (or senders with the same/similar message), Party Y 1301 is queried whether or not to Submit a Level 1 MT Challenge? 1305. If the Party Y 1301 user elects (“Yes” 1306) to submit a Level 1 MT Challenge and warning for the sender to correct the Mail Purpose Type classification in subsequent mailings, then the process will Start Level 1 MT Process 1307. The Level 1 MT Process is further illustrated in detail in FIG. 16. If the user party Y 1301 does not elect (“No” 1312) to submit a Level 1 MT Challenge 1305, then this election ends the recourse process for this instance 1313.

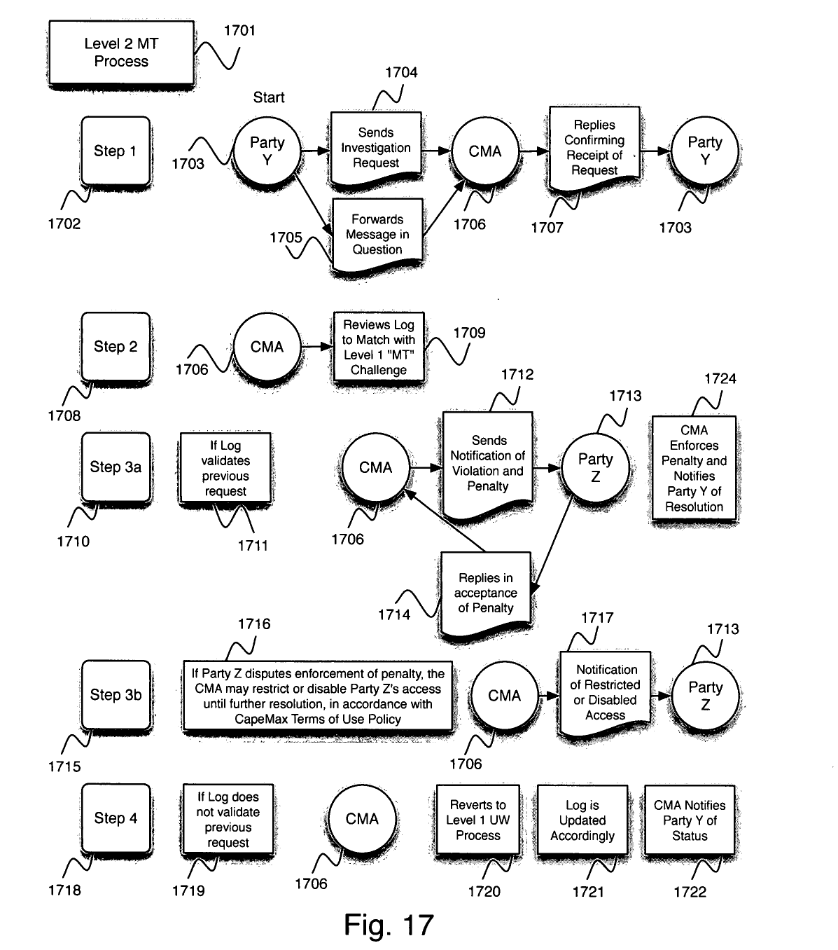

If it is beyond a first occurrence of Mistyped Mail from this sender Party Z (“No” 1308; or senders with the same/similar message) then the Party Y 1301 user is queried whether or not to Submit Level 2 MT Challenge? 1309. If the Party Y 1301 user elects (“Yes” 1310) to submit an “Investigation Request” to the system administrator to determine if a violation has occurred and if a penalty is warranted for the non-response of prior request(s) to correct Mail PurposeType identifications, then the process will Start a Level 2 MT Process 1311. The Level 2 MT Process 1311 is further illustrated in detail in FIG. 17. If Party Y 1301 does not elect (“No” 1314) to submit a Level 2 MT Challenge 1309, than this election ends the recourse process for this instance 1315.

Referring now to FIG. 14, illustrated in detail is The Level 1 UW Process 1401. The Level 1 UW Process details of FIG. 14 proceed from or are a sub-process of the process first indicated in FIG. 12 (c.f., The Level 1 UW Process 1207 of FIG. 12). The Level 1 UW Process is a procedure for handling Do-Not-Send Email Requests from a system user. In step 1 1402, Party Y 1403 submits a Do Not Send Mail Request (DNSMR) 1404 to Party Z 1405 and the system (CapeMax) administrator CMA 1406, which logs the DNSMR 1408 and replies to Party Y 1403 with an acknowledgement indicating request received 1407. In step 2 1409, Party Z 1405 confirms receipt of request and compliance 1410 to the System Administrator (“CMA” 1406), CMA logs the confirmation 1411. In step 3a 1413, the CMA 1406 places Party Z 1405 on aware status 1414. In contingent step 3b 1412, if Party Z 1405 does not follow step 2 1415, then the CMA 1406 sends a Notification of Probationary Account Status 1416 and places Party Z on probationary status 1417. In contingent step 3c 1418, if Party Z 1405 does not respond to step 3b 1419, the CMA 1406 restricts or disables Party Z access until further resolution 1420.

Referring now to FIG. 15, illustrated in detail is The Level 2 UW Process 1501. The Level 2 UW Process details of FIG. 15 proceed from, or are a sub-process of, the process first indicated in FIG. 12 (c.f., The Level 2 UW Process 1215 of FIG. 12). The Level 2 UW Process 1501 is an investigation request. In step 1 1502, Party Y 1503 sends an Investigation Request 1504 along with forwarding the message in question 1505 to the System Administrator (“CMA”, 1506. The CMA 1506 Replies Confirming Receipt of Request 1507 to Party Y 1508. In step 2 1509, the CMA 1506 Reviews Log to Match with Level 1 UW Request 1510. In contingent step 3a 1511, if Log Validates Previous Request 1512, the CMA 1506 Sends Notification of Violation and Penalty 1513 to Party Z 1514. Party Z 1514 replies in Acceptance of Penalty 1515. The CMA Enforces Penalty and Notifies Party Y of Resolution 1516. In contingent step 3b 1524, if Party Z disputes enforcement of penalty, the CMA may restrict or disable Party Z's access until further resolution, in accordance with CapeMax terms of use policy 1517. The CMA 1506 will send Notification of Restricted or Disabled Access 1518 to Party Z 1514. In contingent step 4 1519, If Log Does Not Validate Previous Request 1520, the CMA 1506 reverts to a Level 1 UW Process 1521; the Log is Updated Accordingly 1522 and the CMA Notifies Party Y of Status 1523.

Referring now to FIG. 16, illustrated is the Level 1 MT Process 1601 (User Enforcement Recourse Process). The Level 1 MT Process details of FIG. 16 proceed from, or are a sub-process of, the process first indicated in FIG. 13 (c.f., The Level 1 MT Process 1307 of FIG. 13). In step 1 1602, Party Y 1603 submits a MT challenge for a question of Mail Purpose Type identification (Replies with “MT” challenge 1604) to Party Z 1605 and the CMA 1606. The CMA 1606 then (1) Logs the MT challenge; (2) Checks the Reasonableness of the challenge; and (3) if unreasonable, then the CMA may stop the process and recommend Party Y review Mail Purpose Type descriptions, or suggest the UW process instead 1607. Also, the CMA 1606 replies that the MT challenge was received 1620. In step 2 1608, Party Z 1605 confirms Receipt of MT challenge & Future Compliance 1609 to the CMA 1606. The CMA 1606 then logs the confirmation 1610. In step 3a 1611, the CMA 1606 places Party Z on Aware Status 1612. In contingent step 3b 1613, if Party Z does not follow step 2 1614, then the CMA 1606 sends a Notification of Probationary Account Status 1615 and Places Party Z on Probationary Status 1616. In contingent step 3c 1617, If Party Z does not respond to Step 3b 1618, the CMA 1606 restricts or Disables Party Z access until further resolution 1619.

Referring now to FIG. 17, illustrated is the Level 2 MT Process 1701. The Level 2 MT Process details of FIG. 17 proceed from, or are a sub-process of, the process first indicated in FIG. 13 (c.f., The Level 2 MT Process 1311 of FIG. 13). The Level 2 MT Process 1701 is an investigative request. In step 1 1702, Party Y 1703 sends an Investigation Request 1704 along with the Message in Question 1705 to the CMA 1706, the CMA 1706 then Replies Confirming Receipt of Request 1707 to Party Y 1703. In step 2 1708, the CMA 1706 reviews Log to Match with Level 1 MT challenge 1709 request. In contingent step 3a 1710, If Log Validates Previous Request 1711, the CMA 1706 sends Notification of Violation and Penalty 1712 to Party Z 1713. Party Z 1713 then Replies in Acceptance of Penalty 1714. The CMA Enforces Penalty and Notifies Party Y of Resolution 1724. In contingent step 3b 1715, if Party Z disputes enforcement of penalty, the CMA may restrict or disable Party Z's access until further resolution, in accordance with CapeMax terms of use policy 1716. The CMA 1706 will send Notification of Restricted or Disabled Access 1717 to Party Z 1713. In contingent step 4 1718, If Log does not validate previous request 1719, the CMA 1706: reverts to a Level 1 MT challenge Process 1720; the Log is Updated Accordingly 1721 and the CMA sends notification of status to Party Y 1722.

Although the present invention describes in detail certain embodiments, it is understood that variation and modifications exist known to those skilled in the art that are within the invention. Accordingly, the present invention is intended to encompass all such alternatives, modifications and variation that are within the scope of the invention as set forth in the following claims.

What is claimed is:

1. A system for providing email or other electronic messages between users comprising:
a centralized closed-loop communication network;
a server(s) accessible through secured or encrypted connections for receiving and sending email between users;
a structured user protocol having an enforcement recourse process for said users; and
wherein said system provides a spam-free network system.

2. A system according to claim 1, wherein said communication network is selected from the group consisting of extranet, intranet, Wide Area Network (WAN), Virtual Private Network (VPN) and any combinations thereof.

3. A system according to claim 1, wherein said communication network is an extranet system.

4. A system according to claim 1, wherein said secured or encrypted connections are selected from the group consisting of Secure Sockets Layer (SSL) and Transport Layer Security (TLS).

5. A system according to claim 1, wherein said secured or encrypted connections are Secure Sockets Layer (SSL).

6. A system according to claim 1, wherein said secured or encrypted connections are Transport Layer Security (TLS).

7. A system according to claim 1, wherein said server(s) is/are accessible through a secured login.

8. A system according to claim 1, wherein said server(s) of said system is/are accessible by wireless or wired connections.

9. A system according to claim 1, wherein said system server(s) optionally provides email or other electronic data storage.

10. A system according to claim 1, wherein said enforcement recourse process provides penalties for users selected from the group consisting of service cancellation, service limitation, probationary user status, financial payments, and any combinations thereof.

11. A system according to claim 10, wherein said enforcement recourse process further provides a means for users to challenge said penalties.

12. A system according to claim 1, wherein said system comprises at least one website.

13. A system according to claim 1, wherein said system is accessible by users' computers through any internet connection, through any secured web browser or email software configured to access said system.

14. A system according to claim 1, wherein said user protocol provides for mandatory classification of electronic messages by mail purpose type.

15. A system according to claim 14, wherein said mail purpose type is selected from the group consisting of person-to-person messages, official correspondence, group correspondence, business networks, news and information, and advertisements and promotions.

16. A system according to claim 15, wherein said system further provides users with a means to select a purge timeframe for at least one of the different mail purpose type classifications.

17. A system according to claim 1, wherein said enforcement recourse process of said user protocol of said system provides a means for identifying and remedying unwanted email.

18. A system according to claim 1, wherein said enforcement recourse process of said user protocol of said system provides a means for identifying and remedying mistyped mail purpose type email.

19. A system according to claim 1, wherein said user protocol optionally limits or otherwise restricts the number of recipients which can be addressed to any one email or other electronic message based upon a user's history of use, length of time they have been a user, or a user's selected type or level of service.

20. A method for delivering spam-free email or other electronic messages between users comprising:
providing a system having (i) a centralized closed-loop communication network; (ii) a server(s) accessible through secured or encrypted connections, and (iii) a structured user protocol having an enforcement recourse process; and
receiving and sending email or other electronic messages between users.

21. A method according to claim 20, further including selecting said communication network from the group consisting of extranet, intranet, Wide Area Network (WAN), Virtual Private Network (VPN) and any combinations thereof.

22. A method according to claim 20, including selecting an extranet system as said communication network.

23. A method according to claim 20, including selecting said secured or encrypted connections from the group consisting of Secure Sockets Layer (SSL) and Transport layer Security (TLS).

24. A method according to claim 20, including selecting Secure Sockets Layer (SSL) as said secured or encrypted connections.

25. A method according to claim 20, including selecting Transport Layer Security (TLS) as said secured or encrypted connections.

26. A method according to claim 20, including accessing said server(s) with a secured login.

27. A method according to claim 20, including accessing said server(s) with wireless or wired connections.

28. A method according to claim 20, including providing email or other electronic data storage to said system server(s).

29. A method according to claim 20, including providing an enforcement recourse process having penalties for users selected from the group consisting of service cancellation, service limitation, probationary user status, financial payments, and any combinations thereof.

30. A method according to claim 29, further providing a means for users to challenge said penalties of said enforcement recourse process.

31. A method according to claim 20, including providing at least one website to said system.

32. A method according to claim 20, including accessing said system by users' computers through any internet connection, through any secured web browser or email software configured to access said system.

33. A method according to claim 20, including classifying electronic messages in said user protocol by mail purpose type.

34. A method according to claim 33, including selecting mail purpose type from the group consisting of person-to-person messages, official correspondence, group correspondence, business networks, news and information, and advertisements and promotions.

35. A method according to claim 34, further providing users with a means of selecting purge timeframes for at least one of said mail purpose types.

36. A method according to claim 20, further providing said structured user protocol having an enforcement recourse process with a means for identifying and remedying unwanted email or other electronic messages.

37. A method according to claim 20, further providing said structured user protocol having an enforcement recourse process with a means for identifying and remedying mistyped mail purpose type email.

38. A method according to claim 20, further providing optionally limiting or otherwise restricting the number of recipients which can be addressed to any one email or other electronic message based upon a user's history of use, length of time they have been a user, or a user's selected type or level of service.
